(19) United States
(12) Patent Application Publication
(10) Pub. No.: US 2010/0100371 A1
(43) Pub. Date: Apr. 22, 2010

(54) Method, System, and Apparatus for Message Generation

(76) Inventors: Tang Yuezhong, Beijing (CN); Hu Rile, Beijing (CN)

Correspondence Address: DITTHAVONG MORI & STEINER, P.C., 918 Prince Street, Alexandria, VA, 22314, US

(21) Appl. No.: 12/254,512

(22) Filed: Oct. 20, 2008

(51) Int. Cl. G06F 17/27

(52) U.S. Cl. 704/9

(57) ABSTRACT

Methods, systems, and apparatuses for message generation receive one or more keywords that are indicative of a message subject matter. Based on the keywords, information related to the keywords is searched, and message preferences of a message recipient are determined. A natural language message is created using the information related to the keywords and the message preferences, and the message is sent to the message recipient.

### FIELD OF THE INVENTION

This invention relates in general to computing devices, and more particularly to systems, apparatuses and methods for facilitating message generation.

### BACKGROUND

Mobile computing devices are increasingly being adopted by mainstream users. The combination of easy portability, increasing network availability, and large local storage capabilities will result in mobile devices becoming the primary computing device for many users. Today, such devices are being used for a variety of different types of communication. For example, current and anticipated mobile phone technologies have transformed wireless mobile telephones into powerful tools capable of capturing and communicating voice, data, images, video, and other multimedia content. Mobile phones now often include data messaging capabilities such as text messaging such as short message service (SMS), multimedia messaging service (MMS), instant messaging (IM), e-mail, voice over internet protocol (VoIP), etc.

### SUMMARY

The disclosure relates to a system, apparatus and method for message generation. In one aspect, one or more keywords are received that are indicative of a message subject matter. Based on the keywords, information related to the keywords is searched, and message preferences of a message recipient are determined. A natural language message is created using the information related to the keywords and the message preferences, and the message is sent to the message recipient.

In more particular aspects, the searching further involves deriving supplementary information descriptive of aspects of the subject matter. In such a case forming the natural language message comprises incorporating the supplementary information. In other more particular aspects, the supplementary information may include any combination of location data, contact data, calendar data, images, videos, advertisements, and context data describing a present context of a user device.

In other more particular aspects, the methods, systems, and apparatuses further facilitate searching, based on the keywords, information available via at least one of a user device and a network. In another case, determining message preferences of the message recipient may involve determining a language of the recipient. In such a case, creating the natural language message using the information related to the keywords and the message preferences may involve creating a message in the language of the recipient that is different from a language associated with the keywords.

In other more particular aspects, determining message preferences of the message recipient involves determining at least one of a message type and capabilities of a receiving device of the message recipient.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a functional framework according to an example embodiment of the invention;

FIG. 2-3 are a block diagrams illustrating message generation scenarios according to example embodiments of the invention;

FIG. 4 is a flowchart illustrating a procedure for data collection for message generation according to an example embodiment of the invention;

FIG. 5 is a flowchart illustrating a procedure for message generation according to an example embodiment of the invention;

FIG. 6 is a block diagram of a user device according to an embodiment of the invention; and

FIG. 7 is a flowchart illustrating a procedure for message generation according to an example embodiment of the invention.

### DETAILED DESCRIPTION

In the following description of various example embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

The present disclosure is directed to methods, systems, and apparatus that facilitate the creation of fully formed messages based on minimal user inputs. Such message/text generation may be used on any processing device capable of receiving user input. The described embodiments have the technical effects of improving, for example user input efficiency.

Text generation, as the term is generally used herein, involves generating natural language text using a machine representation system, such as a knowledge base and/or a logical form. The process in the present case starts from the communicative goals of the writer or speaker, for example as input into a user interface of a processing device. The goals may be communicated as keywords that provide a minimal set data needed to form the final message representation, e.g., using full, grammatically correct sentences, and with natural language supplementary data added. The processing device may employ some sort of planning to progressively convert the keywords/goals into written or spoken words.

The general aims of such a language producer are refined into goals that are increasingly linguistic in nature, culminating in low-level goals to produce words. A modularization of the generation process may be involved, which roughly distinguishes between a strategic (deciding what to say) and a tactical (deciding how to say it) part. This strategy-tactics distinction is partly mirrored by a distinction between text planning and sentence generation. Text planning is concerned with working out the large-scale structure of the text to be produced and may also comprise content selection. The result of this sub-process is commonly taken to be a tree-like discourse structure, which has at each leaf an instruction to produce a single sentence. These instructions are then passed in turn to a sentence generator, whose task can be further subdivided into sentence planning, e.g., organizing the content of each sentence. A subsequent step is surface realization, e.g., converting sentence-sized chunks of representation into grammatically correct sentences.

The different types of generation techniques may be classified into four main categories: 1) canned text systems, 2) template systems, 3) phrase-based systems; and 4) feature-based systems. Of these approaches, canned text systems may be the simplest approach for single-sentence and multi-sentence text generation. They may be easier to create than the other categories, but are generally considered to be inflexible. Template systems reflect the next level of sophistication. Template systems apply pre-defined templates or schemas to input data and input actions, and may be able to support flexible alterations. The template approach has been used for multi-sentence generation, such as in applications whose texts are fairly regular in structure.

Phrase-based systems employ what can be seen as generalized templates. In such systems, a phrasal pattern is first selected to match the top level of the input, and then each part of the pattern is recursively expanded into a more specific phrasal pattern that matches some sub-portion of the input. At the sentence level, the phrases resemble phrase structure grammar rules and at the discourse level they play the role of text plans.

Feature-based systems, which presently associated with single-sentence generation, represent each possible minimal alternative of expression by a single feature. Accordingly, each sentence is specified by a unique set of features. In this framework, generation consists in the incremental collection of features appropriate for each portion of the input. Feature collection itself can either be based on unification or on the traversal of a feature selection network. The expressive power of the approach is very high since any distinction in language can be added to the system as a feature. Sophisticated feature-based generators, however, require very complex input and make it difficult to maintain feature interrelationships and control feature selection.

Many natural language generation systems follow a hybrid approach by combining components that utilize different techniques. In the present example embodiments, the user may only need to input some keywords, such as person, action, time, location, etc., and a completed sentence can be generated based on these keywords. Different from the other text generators, this solution could make use of other resources which are available in mobile user devices, such Internet access, calendar, contacts, maps, and so on. In this way, the users could greatly reduce the number of input words need to form a coherent sentence. This may be useful in any devices, such as mobile devices which utilize input methods, such keypad, speech, handwriting, and/or optical character recognition (OCR).

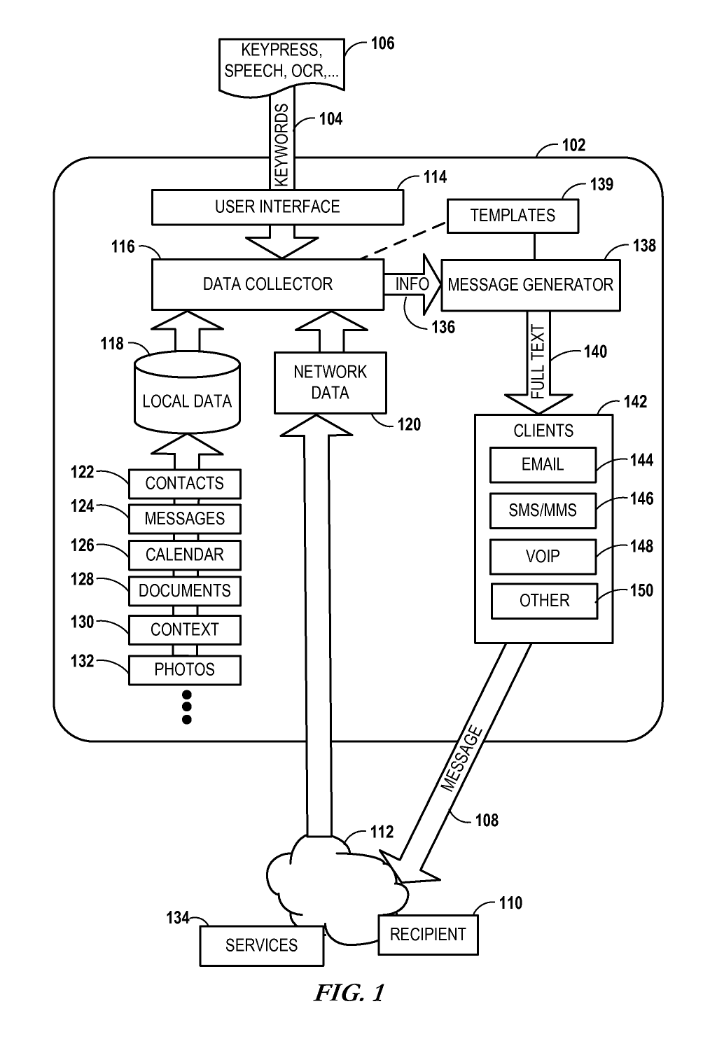

In reference now to FIG. 1, a block diagram illustrates a framework according to an example embodiment of the invention. One or more devices 102 execute various functional blocks that receive keywords 104 from user generated inputs 106. The functional blocks convert the keywords 104 to a fully formed message 108 that is sent to a recipient 110, e.g., via a network 112. The keywords 104 are received via a user interface 114, which may include any combination of hardware and software appropriate for receiving user inputs 106. Example hardware of user interface 124 includes displays, input switches/knobs, touchscreens, microphones, speakers, motion sensors, force inducers, cameras, etc. The example software of the user interface 124 may include graphical user interfaces, speech detection/generation, hardware event detection daemons, OCR, etc.

The keywords 104 are passed from the user interface 114 to a data collector 116, which uses the keywords 104 to gather additional relevant data. The additional data gathered by the data collector 134 may include any combination of locally stored/accessible data 118 and remotely stored/accessible network data 120. The local data 118 may include, for example, contacts 122, messages 124, calendars 126, documents 128, context 130 (e.g., current time, location, network type/availability), and photos 132. Other sources of local data not shown may include one or more media files, videos, figures, bookmarks, user groups, maps, ads, templates, message service providers, etc. The network data 120 may be analogous to the local data 118 (e.g., include network repositories for user contacts, messages, calendars, documents, user context, photos, video, figures, bookmarks, user groups, maps, ads, templates, message service providers, etc.) and may include any other service 134 available via the network 112, such as spelling, translation, localization, etc.

The data collected by the data collector 116 may be processed into output information 136 that is sent to a message generator 138. In forming the information 136, the data collector 116 may perform actions such as sorting, spell checking, tagging/classification, ranking, translation, and other actions that enable the information 136 to be more easily processed by the message generator 138. The tagging/classification of the information 136 may include the insertion of metadata that allows matching parts of the information 136 to language templates 139 accessible via the message generator 138. The information 136 may include other data used for message post-processing, such as an identifier of the recipient 110 and indicator of how the resulting message 108 is to be communicated to the recipient 110.

The message generator 138 takes the collected and processed message information 136 and forms a full-text message 140. Generally, the full-text message 140 is an expansion of the user-input keywords 104, e.g., formatted into full sentences with supplementary information added. The full text message 140 may be formed independent of the ultimate means by which the resulting transmitted message 108 is sent. For example, the full text message 140 may include plain text and/or markup language text that can be used by any number of messaging clients 142. Example messaging clients 142 include email 144, instant messaging 146 such as SMS and MMS, VoIP 148, and any other client 150 known in the art.

The solution is an integrated solution, which can make use of multiple methods and resources to complete the task. The methods used by the data collector 116 and message generator 138 could include keywords searches, sentence matching, use of Web Service, automatic text generator, automatic message generator, and/or the like, or any combination thereof. The resources could be Internet content, SMS/MMS/email data resources, calendar/contact/maps/media resources, which may be stored on a network 112, and/or locally on a mobile device, etc. The message generator 138 may use any combination of automatic text generation, including canned text generation, templates 139, phrase- and/or feature-based generation, Web service, etc.

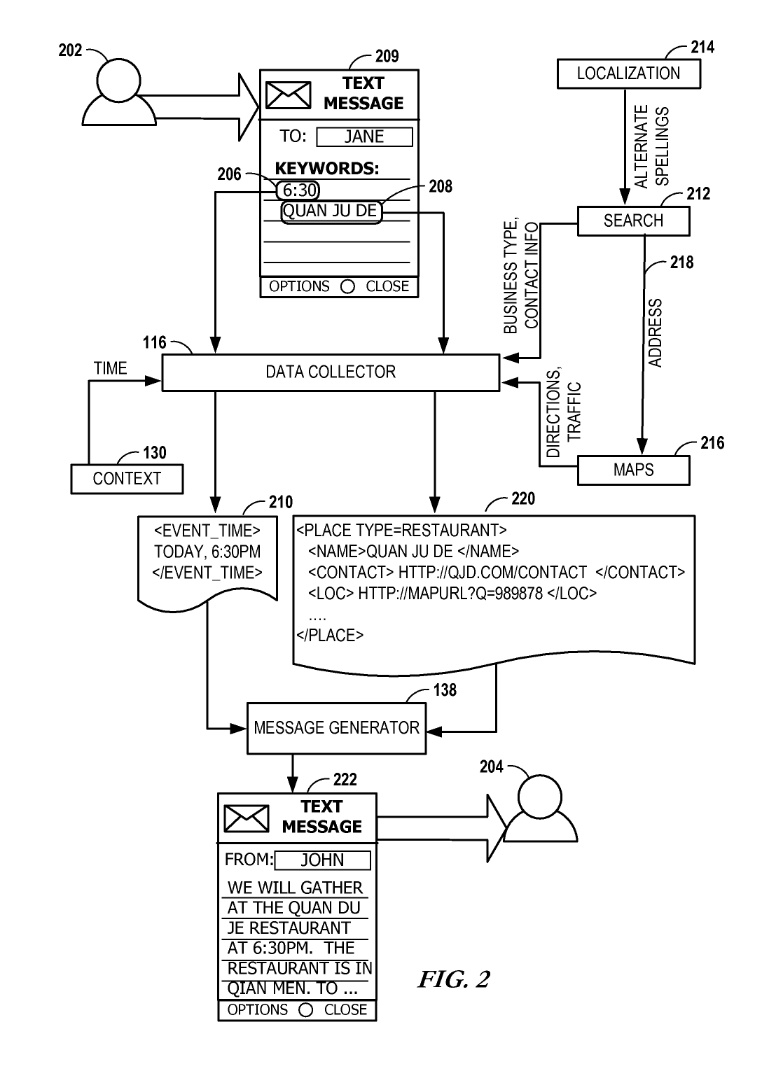

In reference now to FIG. 2, a block diagram shows a use case scenario according to an example embodiment of the invention, wherein the same reference numbers may be used to indicate the same or similar components shown and described in other figures. In the illustrated scenario, user John 202 wants to make an appointment with user Jane 204 in QuanJuDe restaurant, which is a famous toast duck restaurant in Beijing. John may only need to input some keywords 206, 208 (e.g., “6:30,” “QuanJuDe”) into message input screen 209. In this example, the data collector 116 has determined that the keyword 206 is an event time, and this is annotated using tags in an output data 210. Further, the context component 130 determines the edit time is 10:00 AM, the time is automatically adjusted to 6:30 PM (e.g., as opposed to 6:30 AM) as seen in the output data 210.

The keyword 208 “QuanJuDe” is searched via an Internet search service 212, and it is determined that the name refers to a toast duck restaurant (e.g., “place type=restaurant”). The context component 130 may be used to refine this search. For example, location sensing (e.g., GPS) in John's mobile device may narrow the search to locations within a reasonable distance from John's current location at or near Beijing to more accurately determine what keyword 208 refers to, and to determine contact information of the restaurant, for example. In another example, a local or online language localization service 214 may be used to find alternate spellings (e.g., “Quan Joo De”) to account for known spelling variations when writing certain non-Western (e.g., Asian) languages using Western alphabets/characters. Further, other local/remote stored data (e.g., browser bookmarks) may also be used to locate and confirm the accuracy of the data regarding this restaurant

Using an in-device or network-based mapping service 216, the location, directions, and/or traffic data for QuanJuDe may also be found. Note that an address 218 determined from the search service 212 is shown being used as input to the map service 216 to determine mapping data such as latitude/longitude, directions, traffic conditions, etc. In this case the directions to the restaurant are intended for the recipient 204, so other locally or remotely stored contact information (e.g., home or work address of Jane 204) can be used as inputs to the mapping service 216 as well. The data collected for keyword 208 is shown as tagged data 220.

Depending on this information, the message generator 138 could make use of text generator technology, and/or the message generator 138 could also search for complete sentences using the data 210, 220 collected based on the keywords 206, 208. The search may be done locally, or via the Internet, e.g., using a specific Web Service which is tailored to natural language generation services. Previously sent SMS (or other messages) may also be searched to find similar phrases, sentences, templates, etc., associated with the keywords. In this way, the message generator 138 could form a message 222 having complete sentences as follows: “We will gather at the QuanJuDe restaurant at 6:30 pm. The restaurant is in QianMen. To get there you could take the Line 2 subway. The restaurant contact number is 826939911”. Moreover, the message generator even could transfer it via an MMS client (e.g., client 146 shown in FIG. 10) with the pictures of QuanJuDe map and the toast duck.

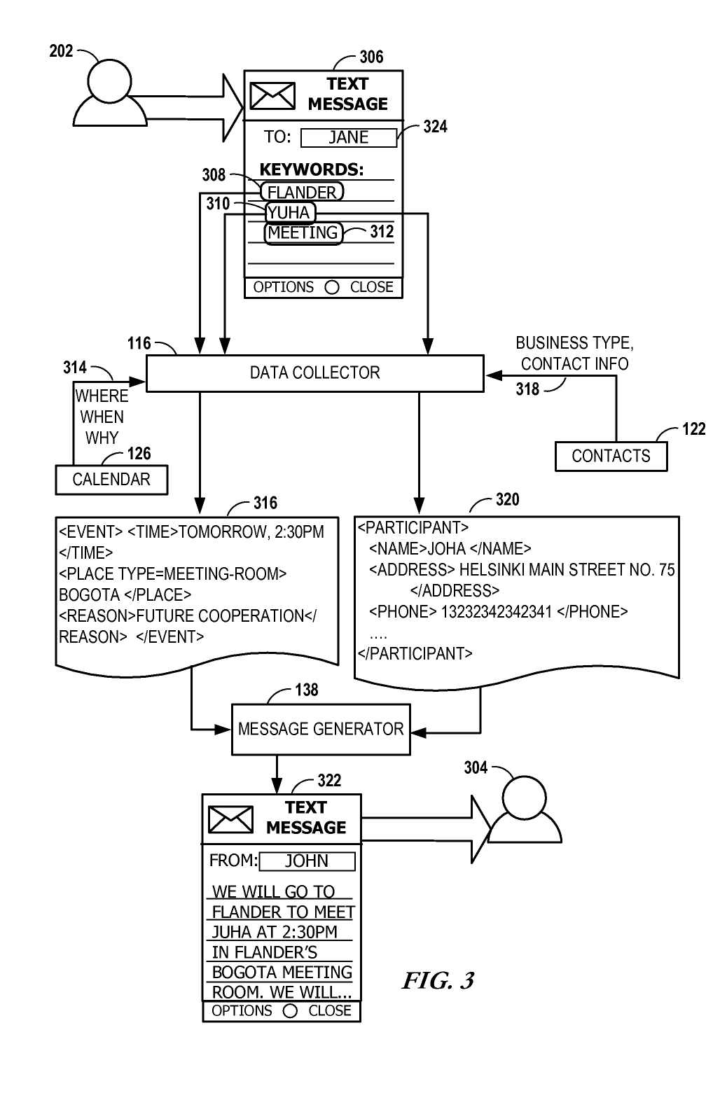

In reference now to FIG. 3, a block diagram shows a use case scenario according to an example embodiment of the invention, wherein the same reference numbers may be used to indicate the same or similar components shown and described in other figures. John 202 and Holly 304 are colleagues, and Juha (not shown) is a manager of a local partner, “Flander.” All three will have a meeting in Juha's office. John 302 labeled the meeting in his calendar two days before. John 202 wants to send an SMS to Holly to remind her. As seen in input screen 306, John 202 only inputs three keywords, “Flander” 308, “Juha” 310, and “meeting” 312.

According to these keywords 308, 310, 312, the calendar 126 is queried 314. Query 314 of the calendar entries may be able to determine, e.g., where, when, and why based on inputs such as what (e.g., “meeting” 312) and who (e.g., “Flander” 308, “Yuha” 310). Further, the calendar 126 may be chosen as a likely source of answers based on one or more of the keywords (e.g., “meeting” 312). In this case, the following related information is available in one or more calendar entries: meeting room—“Bogota”; meeting time—“2:30 pm”; topic—“future cooperation.” This is reflected in tagged data 316.

Based on the calendar query 314 and/or keywords 308, 310, 312, the data collector 116 may determine that additional data is needed from the contact data 122, such as the contact information for Juha. A query 318 returns, for example, Juha's address (e.g., Helsinki Main street No. 75), and Juha's phone number, which is shown as tagged data 320. Based on all of the collected information 316, 320, the text generator 138 (or a Web service) is used to form a complete message text. The generator 138 may select the following example sentences based on the inputs 316, 320: “We will go to Flander to meet Juha at 2:30 in Flander's Bogota meeting room. We discuss our future cooperation. Flander is located on Main Street, No. 75. The phone number is 13232342342341”. This is used to form completed message 322, that may be sent via SMS. The contents of this message 322 could also be transferred to Holly 304 via MMS and/or email, and include the map to Flander (e.g., via the help of map service 216 in FIG. 2).

It will be appreciated that many variations are possible in light of the above teachings. For example, such a system may effectively integrate translation technologies into message formation. Because the inputs to such a system are simple keywords, the selection of grammatically correct phrases and sentences in numerous languages may be possible. For example, the translation of individual words may be easier than the sentence translation. Such a translation based on keywords may be more effective than full-sentence-to-full-sentence translation, because the keyword approach can utilize simpler ideas and grammatical structures that are less prone to misinterpretation by computerized translation technologies. Such translation technology could also be integrated in the framework via local processing modules and/or network services. Thus, this solution provides technical features that may include both improving message-forming efficiency and enhancing the message translation performance and accuracy. For example, even though the sender and recipient may natively read Chinese, it may be more efficient to input simple Western-language keywords (e.g. English, French, Spanish) on a Western alphabet keypad, and then have the system form the full message in a Chinese language and using Chinese characters.

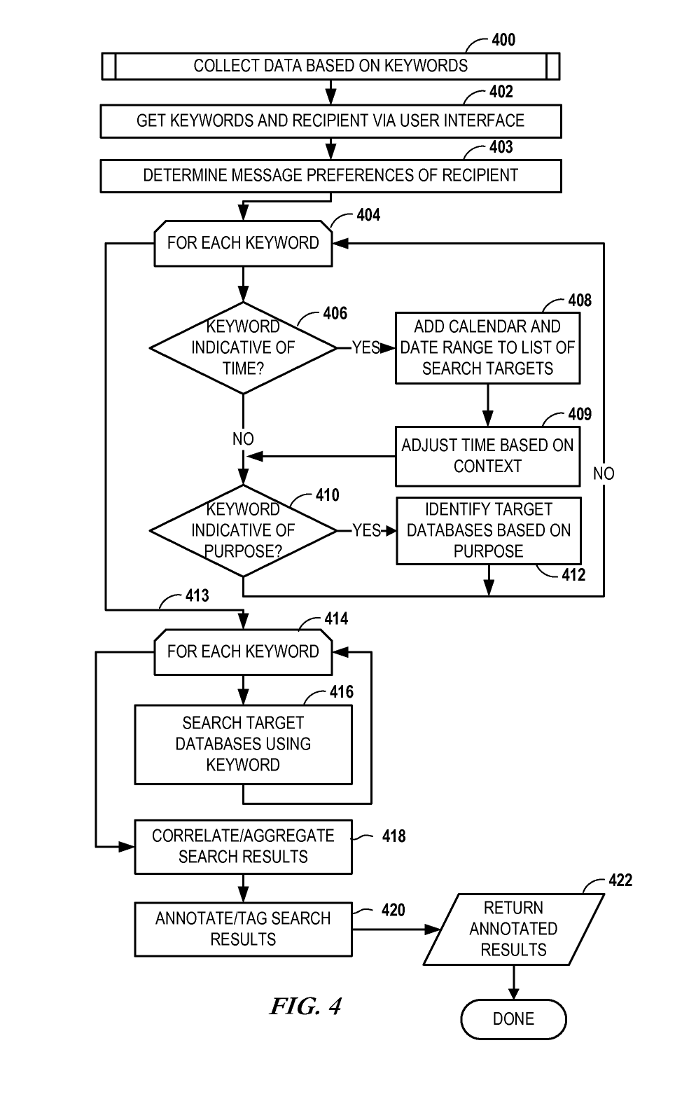

In reference now to FIG. 4, a flowchart shows a procedure 400 for collecting data based on user input keywords (e.g., via data collector component 116) to assist in message generation according to an example embodiment of the invention. Keywords are received 402 via a user interface (e.g., user interface 114 in FIG. 1 and screens 209, 306 in FIGS. 2-3). Although screens 209, 306 in FIGS. 2-3 show specifically identified keywords (e.g., keyword 308 in FIG. 3) it will be appreciated that, depending on the implementation, the recipient of the message (e.g., block 324 in FIG. 3) may also be relevant and treated as a keyword.

Each recipient determined at 402 may have different message preferences that are relevant to search, message formation, and/or message transmission. Therefore, the procedure may involve determining 403 message preferences of the recipient. These preferences may include, but are not limited to, language, message type, and device capabilities/type. As described above, the messages formed from keywords may be formed in a different language than that associated with the sender and/or keywords used to form the message. The recipient may have message type preferences, including transmission application/protocol (e.g., SMS, MMS, email, etc.), message format (e.g., plaintext, hypertext, voicemail, paging, etc.), etc. These message formats and types may also take into account capabilities of the recipient's receiving device, including display size, memory size, message capabilities, phone/SMS/email capability, etc. The information determined 403 about the recipient may be obtained from local/remote contact information, by available address information/type, public network personal and/or device profiles, etc.

After determining the keywords 402 and recipient preferences 403, the procedure iterates 404 through each of the keywords in an attempt to identify/rank target databases. For example, if it is determined 406 that the keyword indicates a date and/or time (e.g., HH:MM, “tomorrow,” “next week”) then associated date/time ranges within respective databases (e.g., a calendar database) may be flagged 408 for future consideration as highly relevant. Also, as discussed above in relation to FIG. 2, the time may be adjusted 409 based on a terminal context. This adjustment may involve more precise description of the time (e.g., determining whether AM or PM), expanding descriptive text (e.g., tomorrow) to actual date time representations and vice versa, etc.

The keywords may also be determined 410 to be indicative of a purpose that also aids in determining 412 search targets. For example, terms that describe an event such as “meeting,” “concert,” “lunch,” etc., may indicate that calendar data is relevant. Other data such as proper names of people may indicate that a contacts database should be searched, and place names may indicate a maps database should be searched. Whether these determinations 406, 410 are positive or not, it will be appreciated additional search databases that were not flagged may still be searched. These determinations 406, 410 are intended to identify/rank data sources of interest in order to reduce the search space and a more converge on correct results.

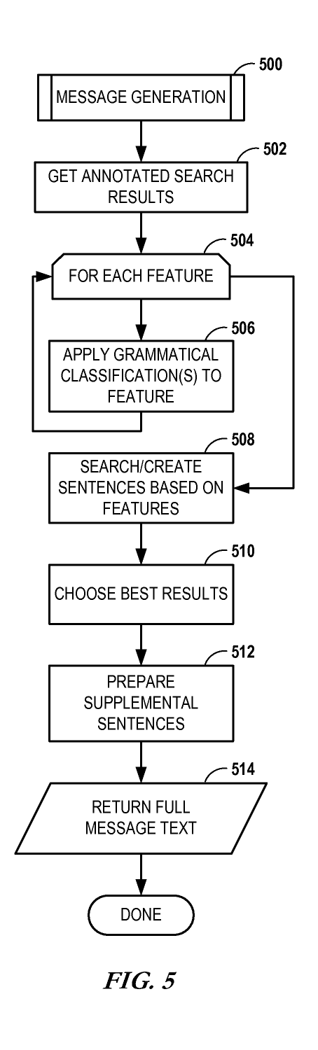

Although the identification of search targets in the iteration 404 may be context free (e.g., analysis of keyword does not rely on what came before or after it) such context may be taken into account. For example, multiple words might be intended to be combined into a single object/feature (e.g., “John's office”). In other cases, the type of user interface may handle the conglomeration of terms before processing, such as providing a separate text input component for each “keyword” (which may include one more words), and/or by using an easy to understand punctuation (e.g., use of quotes, dashes, underscores, etc.). Also, certain recipient preferences, such as target language, may dictate the form of the queries (e.g., keywords are pre-translated into the target language before searching) and thus affect which targeted databases might be used. If translation is required, it may be carried out in one or both of data collection phase (e.g., FIG. 4) and message generation phase (e.g., FIG. 5).

After the keyword iteration 404 is complete (indicated by path 413), the keywords are again iterated as indicated by block 414 to do the search 416 for additional data. It may be useful to fully identify all the search targets in loop 404 before searching for related information in loop 414. This is because some of the keywords may be useful in limiting the search domain, and therefore all keywords could be examined for this purpose before performing any search. For example, if a time/date is included as the last entry in a list of keywords and searches for keywords preceding the time/date are carried out, those previous searches may not have the benefit of date restrictions that will increase search efficiencies. Again, the searches 416 may be carried out in a different language than a language of the keywords and/or message sender.

The results of the searches 416 can be correlated and aggregated 418 in order to more positively determine the ultimate subject of the message. For example, if the first keyword is “Jim” (e.g., explicitly entered as a keyword and/or identified as a message recipient) and the remaining keywords are “can't dentist tomorrow” the first keyword may be used to positively identify “Jim” from the contacts database, and “dentist” and “tomorrow” may be used to determine that the sender has a calendar appointment for a dentist visit for the next day. However, what “can't” refers to may not be clear from these two pieces of information. If the search 416 through a message database indicates that Jim earlier sent an email to the sender saying “How about a game of tennis on Wednesday?” the system may be able to determine the intended subject of the message “Can't play tennis, I have a dental appointment.” A similar result may be obtained, for example, by seeing conflicting appointments for “tennis with Jim” and “dental appointment” in the sender's calendar.

Such correlation 418 may require user input to resolve conflicts. For example, a chain restaurant may found as the object of a search, but the location of the chain that is intended as the target may not be clear based on the context. For example, a current location, home address, and office address of sender and/or recipient may be identified as possible locations. In such a case, the user may be presented with a selectable list of likely chain locations before forming the final message text. In other cases, the data can automatically be correlated/aggregated without requiring user input, such as pulling addresses as needed from a contacts or address database, and obtaining URLs or images from a mapping database.

The aggregated/correlated data can be annotated/tagged 420 for purposes of natural language generation. This may at least be used to identify, based on the keywords, a number of “features” each having a conventional meaning in the target language-generation technique. These features may individually answer questions such as who, what, where, when, how, why, and it can be left up to the message generator to correctly interpret these basic classifications appropriate to the grammar and syntax of the target language.

In reference now to FIG. 5, a flowchart shows a procedure 500 for generating message based on annotated data collected based on user keywords (e.g., via message generator component 138) according to an example embodiment of the invention. The inputs to the procedure 500 may include search results 502 that are organized and/or annotated in a way suited to the natural language generation techniques used. It will be appreciated that the various steps of the procedure 500 may applicable to any natural language, and may be independent of the language of the search results 502 and/or keywords used to determined those search results 502.

As described in relation to FIG. 4, the results 502 may describe different features (e.g., events, persons, places, activities) the procedure may iterate 504 through each of those features to apply 506 a grammatical classification for the feature (e.g., subject, predicate, object, modifier, etc.). There are numerous ways that grammatical analyses 506 can be done, and the details of those analysis techniques are beyond the scope of this disclosure. Generally, many of these techniques can utilize a refined/targeted approach based on the social/personal context in which it may be assumed the messages are being formed, e.g., a mobile device user forming a short message to a recipient. For example, a large majority of messages to mobile users may be classified into certain broad categories such as coordinating meetings/events, question/response, news report, etc. Based on one or more of these categories, appropriate phrase/sentence constructs may be chosen from the much larger universe of meanings that might be applied to a given set of keywords.

Based on classification 506, full sentences may be searched for and/or created 508 depending on the underlying natural language generation architecture. Such formation/searching 508 may return multiple results, and rank results based on the measures to the natural language generation architecture. Assuming that more than one distinct message could be formed, the best result(s) may be chosen 510 either automatically and/or in response to further user input. The resulting message is returned 514, such as to be sent using the appropriate message transfer means (e.g., clients 142 in FIG. 1).

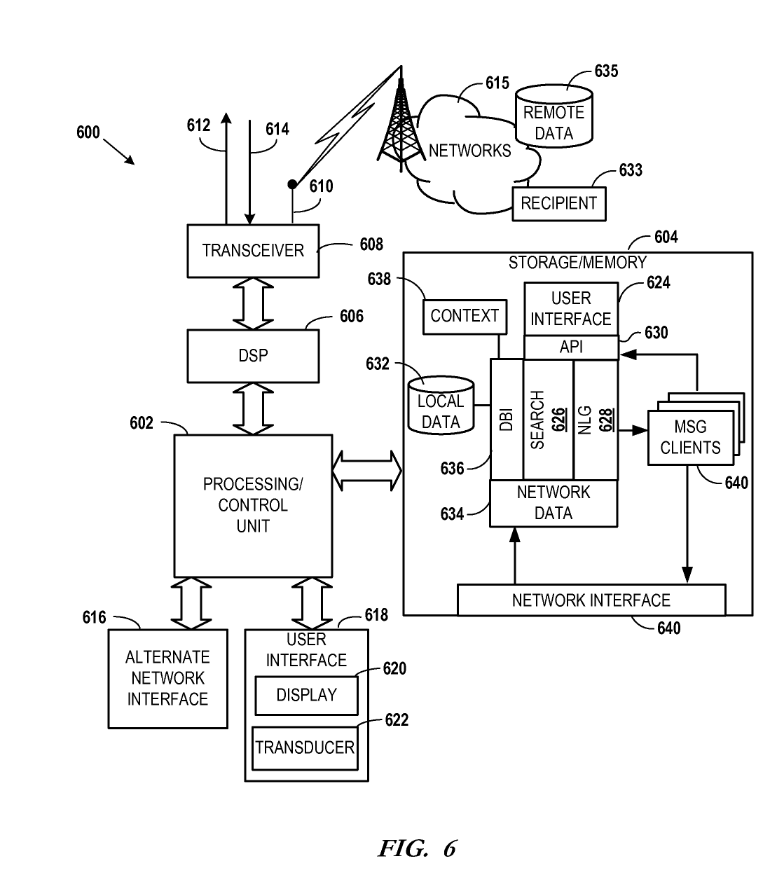

Many types of apparatuses may be used for message generation as described herein, including mobile devices. In reference now to FIG. 6, an example embodiment is illustrated of a representative computing arrangement 600 capable of carrying out operations in accordance with embodiments of the invention. Those skilled in the art will appreciate that the example computing arrangement 600 is merely representative of general functions that may be associated with a mobile apparatus, and/or landline apparatus. The computing arrangement 600 may be for example a mobile computing arrangement, mobile phone, mobile communication device, mobile computer, laptop computer, desk top computer, server computer, phone device, video phone, conference phone, television apparatus, digital video recorder (DVR), set-top box (STB), radio apparatus, audio/video player, game device, positioning device, digital camera/camcorder, and/or the like, or any combination thereof. Further the user computing arrangement 600 may use hardware and software modules as described in FIGS. 1-3.

The processing unit 602 controls the basic functions of the arrangement 600, and may include one or more specialized or general-purpose logic units for processing instructions. The instructions may be stored with the processing unit 602 and/or in a program storage/memory 604. In one example embodiment of the invention, the program modules associated with the storage/memory 604 are stored on- or off-processor in non-volatile electrically-erasable, programmable read-only memory (EEPROM), flash read-only memory (ROM), hard-drive, etc. so that the information is not lost upon power down of the mobile terminal. The relevant software for carrying out mobile terminal operations in accordance with the present invention may also provided to the storage/memory 604 by computer readable medium and/or computer program products. Such software may also be transmitted to the mobile computing arrangement 600 via data signals, such as being downloaded electronically via one or more networks, such as the Internet and intermediate wireless network(s).

The mobile computing arrangement 600 may include hardware and software components coupled to the processing/control unit 602 for performing network data exchanges. The mobile computing arrangement 600 may include multiple network interfaces for maintaining any combination of wired or wireless data connections. The illustrated mobile computing arrangement 600 includes wireless data transmission circuitry for performing network data exchanges. This wireless circuitry includes a digital signal processor (DSP) 606 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 608, generally coupled to an antenna 610, transmits the outgoing radio signals 612 and receives the incoming radio signals 614 associated with the wireless device. These components may enable the arrangement 600 to join in one or more networks 615, including mobile service provider networks, local networks, and public networks such as the Internet.

The mobile computing arrangement 600 may also include an alternate network/data interface 616 coupled to the processing/control unit 602. The alternate network/data interface 616 may include the ability to communicate via secondary data paths using any manner of data transmission medium, including wired and wireless mediums. Examples of alternate network/data interfaces 616 include USB, Bluetooth, Ethernet, 602.11 Wi-Fi, IRDA, Ultra Wide Band, WiBree, etc. These alternate interfaces 616 may also be capable of communicating via the networks 615, or via direct and/or peer-to-peer communications links.

The processor 602 is also coupled to user-interface hardware 618 associated with the mobile terminal. The user-interface 618 of the mobile terminal may include, for example, a display 620 such as a liquid crystal display and a transducer 622. The transducer 622 may include any input device capable of receiving user inputs. The transducer 622 may also include sensing devices capable of determining context (e.g., location, physical states, time, etc.), producing media (e.g., text, still pictures, video, sound, etc.) and other sensing functions known in the art. Other user-interface hardware/software may be included in the interface 618, such as keypads, speakers, microphones, voice commands, switches, touch pad/screen, pointing devices, trackball, joystick, vibration generators, lights, etc. These and other user-interface components are coupled to the processor 602 as is known in the art.

The program storage/memory 604 may include operating systems for carrying out functions and applications associated with functions on the mobile computing arrangement 600. The program storage 604 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 604 of the mobile computing arrangement 600 may also include software modules for performing functions according to embodiments of the present invention.

For example, the program storage/memory 604 includes a user interface 624 that is configured to receive keywords and other inputs from a user for facilitating message auto-generation by respective search and natural language generation (NLG) modules 626, 628. The user interface 624 may be part of the functionality of the modules 626, 628, or may be part of a separate application that communicates by way of an application program interface (API) 630 with the modules 626, 628.

The user interface 624 and message generation modules 626, 628 may contain similar functionality as respective user interface 114, data collector 116, and message generator 138 shown and described in relation to FIGS. 1-3. Generally, the search module 626 may search local data 632 and remote data 635 (e.g., via networks 615). The remote data 635 may be accessed via a network data interface 634. A database interface (DBI) 636 may provide a generic and extensible interface for accessing multiple types of local and/or remote data 632, 635.

As previously described above, the local and remote data 632, 635 may include data associated with user application such as email, telephony, text messaging, video, media playback, navigation, productivity, contacts, calendaring, content creation, preferences, etc., and may also include message preferences associated with a message recipient 633. The search module 626 and/or DBI 636 may also be able to access context data 638 or other dynamically sensed data of the mobile computing arrangement 600. The search module 626 generally takes user inputs (e.g., keywords, recipient identity) from the user interface 624 and uses the keywords to form search queries of local and remote data 632, 635. These queries can better define the keywords and context of the message, and may perform other tasks such as defining a target language and translation. The NLG module 628 takes processed data from the search module 626 and forms grammatically correct, natural language messages, that can be sent to the recipient 633 via custom or previously existing message clients 640.

The message clients 640 may include clients previously described (e.g., clients 142 in FIG. 1) and may be chosen based on message type, recipient preferences, etc. The clients 640 may operate in the background in response to inputs from the user interface 624, and/or the clients 640 themselves may be extended by the functions of message auto-generation as described herein (e.g., as represented by modules 626, 628, etc.). This is indicated by path 642, where one or more of the message clients 640 can accept user-entered keywords and initiate auto-generation via the user interface API 630.

The mobile computing arrangement 600 of FIG. 6 is provided as a representative example embodiment of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

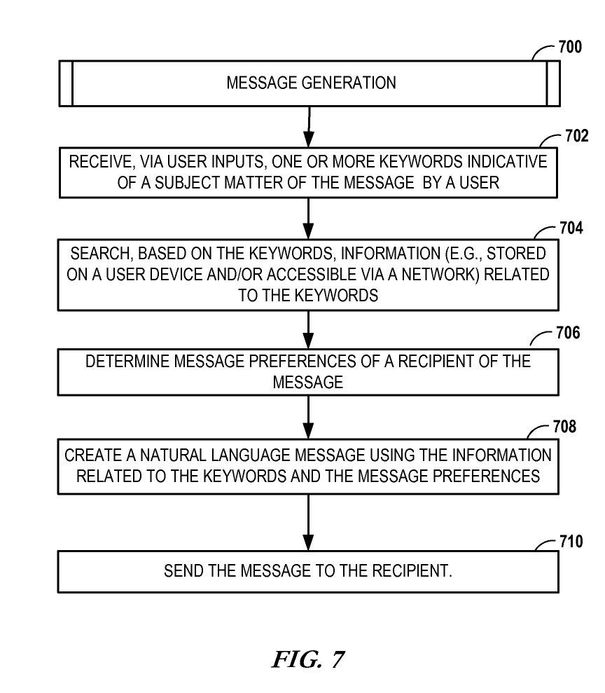

In reference now to FIG. 7, a flowchart shows a procedure 700 for auto-generating messages according to another example embodiment of the invention. The procedure 700 involves receiving 702 one or more keywords input to a device by a user. The keywords are at least indicative of a message subject matter, and may also indicate a recipient of the message. Based on the keywords, information stored on the device related to the keywords is searched 704, and network data may optionally be searched. Message preferences of a message recipient are determined 706, and a natural language message is created 708 using the information related to the keywords and the message preferences. The created message is sent 710 to the message recipient.

Any of the steps described or illustrated herein may be implemented using executable instructions in a general-purpose or special-purpose processor and stored on a computer-readable storage medium (e.g., disk, memory, or the like) to be executed by such a processor. References to “computer-readable storage medium,” “computer program products,” and “computer” should be understood to encompass specialized circuits such as field-programmable gate arrays, application-specific integrated circuits (ASICs), signal processing devices, computer program products, and other devices.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method, comprising:
receiving one or more keywords input by a user, wherein the keywords are indicative of a message subject matter;
searching, based on the keywords, information related to the keywords;
determining message preferences of a message recipient;
creating a natural language message using the information related to the keywords and the message preferences; and
sending the message to the message recipient.

2. The method of claim 1, wherein the searching further comprises deriving supplementary information descriptive of aspects of the subject matter, wherein forming the natural language message comprises incorporating the supplementary information.

3. The method of claim 2, wherein the supplementary information comprises at least one of location data, contact data, and calendar data.

4. The method of claim 2, wherein the supplementary information comprises at least one of images, videos, and advertisements.

5. The method of claim 2, wherein the supplementary data comprises context data describing a present context of a user device.

6. The method of claim 1, further comprising searching, based on the keywords, information available via at least one of a user device and a network.

7. The method of claim 1, wherein determining message preferences of the message recipient comprises determining a language of the recipient.

8. The method of claim 7, wherein creating the natural language message using the information related to the keywords and the message preferences comprises creating a message in the language of the recipient that is different from a language associated with the keywords.

9. The method of claim 1, wherein determining message preferences of the message recipient comprises determining at least one of a message type and capabilities of a receiving device of the message recipient.

10. An apparatus comprising:
a processor programmed with instructions that cause the apparatus to,
receive one or more keywords input by a user, wherein the keywords are indicative of a subject matter of the message;
search, based on the keywords, information related to the keywords;
determine message preferences of a recipient of the message;
create a natural language message using the information related to the keywords and the message preferences; and
send the message to the recipient.

11. The apparatus of claim 10, wherein the searching further comprises deriving supplementary information descriptive of aspects of the subject matter, wherein forming the natural language message comprises incorporating the supplementary information.

12. The apparatus of claim 11, wherein the supplementary information comprises at least one of location data, contact data, and calendar data.

13. The apparatus of claim 11, wherein the supplementary information comprises at least one of images, videos, and advertisements.

14. The apparatus of claim 11, wherein the supplementary data comprises context data describing a present context of the apparatus.

15. The apparatus of claim 10, wherein the instructions further cause the apparatus to search, based on the keywords, information available via at least one of the apparatus and a network.

16. The apparatus of claim 10, wherein determining message preferences of the message recipient comprises determining a language of the recipient.

17. The apparatus of claim 16, wherein creating the natural language message using the information related to the keywords and the message preferences comprises creating a message in the language of the recipient that is different from a language associated with the keywords.

18. The apparatus of claim 10, wherein determining message preferences of the message recipient comprises determining at least one of a message type and capabilities of a receiving device of the message recipient.

19. A computer-readable storage medium encoded with instructions that, when executed by an apparatus, perform:
receiving one or more keywords input by a user, wherein the keywords are indicative of a message subject matter;
searching, based on the keywords, information related to the keywords;
determining message preferences of a message recipient;
creating a natural language message using the information related to the keywords and the message preferences; and
sending the message to the message recipient.

20. The computer-readable storage medium of claim 19, wherein the searching further comprises deriving supplementary information descriptive of aspects of the subject matter, wherein forming the natural language message comprises incorporating the supplementary information.

21. The computer-readable storage medium of claim 20, wherein the supplementary information comprises at least one of location data, contact data, calendar data, images, videos, advertisements, and context data describing a present context of the apparatus.

22. The computer-readable storage medium of claim 19, further comprising searching, based on the keywords, information available via at least one of the apparatus and a network.

23. The computer-readable storage medium of claim 19, wherein determining message preferences of the message recipient comprises determining a language of the recipient.

24. The computer-readable storage medium of claim 23, wherein creating the natural language message using the information related to the keywords and the message preferences comprises creating a message in the language of the recipient that is different from a language associated with the keywords.

25. An apparatus comprising:
means for receiving one or more keywords input by a user, wherein the keywords are indicative of a message subject matter;
means for searching, based on the keywords, information related to the keywords;
means for determining message preferences of a message recipient;
means for creating a natural language message using the information related to the keywords and the message preferences; and
means for sending the message to the message recipient.
